(19) United States
(12) Patent Application Publication
(10) Pub. No.: US 2025/0192411 A1
(43) Pub. Date: Jun. 12, 2025

(54) FILTER FOR COMMUNICATION DEVICE

(71) Applicant: KMW INC., Hwaseong-si (KR)

(72) Inventors: Nam Shin PARK, Hwaseong-si (KR); Sung Ho JANG, Yongin-si (KR); Jae Hong KIM, Yongin-si (KR); Yeon Ho SHIN, Yongin-si (KR); Jeong Moon OH, Hwaseong-si (KR)

(73) Assignee: KMW INC., Hwaseong-si (KR)

(21) Appl. No.: 19/060,638

(22) Filed: Feb. 22, 2025

Related U.S. Application Data
(63) Continuation of application No. PCT/KR2023/012581, filed on Aug. 24, 2023.

(30) Foreign Application Priority Data
Aug. 26, 2022 (KR) 10-2022-0107873
Aug. 23, 2023 (KR) 10-2023-0110841

(51) Int. Cl. H01P 1/207

(52) U.S. Cl. CPC H01P 1/207

(57) ABSTRACT

Disclosed herein may be a filter for communication devices. The filter may include a base plate made of a conductive material, manufactured in an unfolded state and configured to be foldable such that, upon folding, a cavity is formed inside while simultaneously positioning a plurality of resonators to protrude by a set length in a thickness direction or a width direction in the cavity. The plurality of resonators each have a distal end portion having a wider width than a remaining portion, and include a resonance characteristic end formed by curling opposite widthwise ends of the distal end portion in a rounded shape in one thickness direction from a leading end of the remaining portion. The aforementioned configuration provides advantages of facilitating a slim product design, reducing insertion loss, and enhancing resonance characteristics.

### TECHNICAL FIELD

The present disclosure relates to a filter for communication devices and, more particularly, to a filter for communication devices that is easy to manufacture, facilitates securing of a usable area of a main board (or power amplifier (PA) board), and prevents an increase in the size of an entire antenna device in a thickness direction.

### BACKGROUND ART

Radio frequency devices (including all “communication devices”), such as radio frequency filters, are typically configured with a connected structure of a plurality of resonators are circuit elements that resonators. Such resonate at specific frequencies through a combination of an inductor (L) and a capacitor (C) in terms of equivalent electronic circuits. Each resonator has a structure in which a dielectric resonance element (DR) or a metallic resonance element is installed in a cavity, such as a metallic cylindrical or rectangular parallelopiped cavity enclosed by conductors. Accordingly, each resonator allows only an electromagnetic field of a unique frequency corresponding to a processing frequency band to exist within the associated cavity, thereby enabling high-frequency resonance. Typically, the resonator has a multi-stage structure in which a plurality of cavities are used to form a plurality of resonant stages, and the plurality of resonant stages are sequentially connected.

An example of a radio frequency filter having a multi-cavity structure may include the invention disclosed in Korean Patent Application Laid-Open No. 10-2004-0100084 (Title: “Radio frequency filter,” Publication Date: Dec. 2, 2004), which was previously filed by the present applicant.

However, conventional radio frequency filters are configured such that each resonator extends in a thickness direction within a cavity, and a portion of a filter tuning cover, which covers the cavity to achieve desired band-pass characteristics, is deformed through a punching process to tune the distance to the resonator, resulting in a significant limitation in reducing the size of the completed filter in the thickness direction.

Furthermore, conventional radio frequency filters require installation of additional conductive components to implement inductive coupling or capacitive coupling as part of enhancing skirt characteristics between adjacent resonators or spaced-apart resonators within a plurality of cavities, resulting in a significant increase in the weight of the completed filter. Recently, in antenna devices utilizing massive multiple input multiple output (MMO) technology, research has been conducted to minimize the thickness of internal components, such as filters, to achieve a slimmer overall product design. Among the most commonly used filter types for the foregoing purpose, a dielectric ceramic filter is a representative example.

However, dielectric ceramic filters, due to the characteristics of the material thereof, are configured to be directly coupled in close contact with one surface of a main board (or PA board) stacked inside an antenna housing, thereby inherently limiting the double-sided use of a printed circuit board (PCB).

### DISCLOSURE

### Technical Problem

The present disclosure has been made to solve the technical problem, and an object of the present disclosure is to provide a filter for communication devices that can eliminate conventional joining processes for forming a cavity and providing structures such as resonators within the cavity, thereby reducing insertion loss caused by coupling of two physical structures.

Furthermore, another object of the present invention is to provide a filter for communication devices, in which resonance characteristic ends of a plurality of resonators provided in a cavity can be easily manufactured using a folding method.

The technical objects of the present disclosure are not limited to the above-stated objects, and those skilled in the art will clearly understand other not mentioned objects from the following description.

### Technical Solution

A filter for communication devices according to an embodiment of the present disclosure may include a base plate made of a conductive material, and manufactured in an unfolded state, the base plate being configured foldable such that, upon folding, a cavity is formed inside while simultaneously positioning a plurality resonators to protrude by a set length in a thickness direction or a width direction in the cavity. The plurality of resonators may each have a distal end portion having a wider width than a remaining portion, and include a resonance characteristic end formed by curling opposite widthwise ends of the distal end portion in a rounded shape in one thickness direction from a leading end of the remaining portion.

Here, at least one of the plurality of resonators may be connected with an input terminal pin that is provided as a separate element and connected to an input port of a main board so that a signal transmitted from the input port is received. At least one other of the plurality of resonators may be connected with an output terminal pin that is provided as a separate element and connected to an output port of the main board so that a signal is transmitted to the output port and then output.

Furthermore, the opposite rounded widthwise ends of the resonance characteristic end of each of the plurality of resonators may be spaced apart from each other by a set distance.

Furthermore, the resonance characteristic end of each of the plurality of resonators may be formed to have at least one circular or semicircular horizontal cross-section.

In addition, the base plate may be made of either a conductive material or a non-conductive material. In case that the base plate is made of the non-conductive material, a conductive material may be formed as a coating layer by plating at least on an interior corresponding to the cavity.

Additionally, the cavity may be filled with air having a dielectric constant of 1.

Furthermore, the base plate, after folding, may include
a body bottom forming panel that forms a bottom surface of the cavity, a first-side thickness forming panel and a second-side thickness forming panel that increase a size of the cavity in the thickness direction, and a body top forming panel provided in a shape covering a top of the cavity.

Furthermore, the body bottom forming panel may include a first-side body bottom forming panel that forms a first-side bottom surface of the cavity, and a second-side body bottom forming panel that forms a second-side bottom surface of the cavity. The first-side body bottom forming panel and the second-side body bottom forming panel may form a complete bottom surface of the cavity after folding.

In addition, the base plate, after folding, may further include a first-side shielding panel and a second-side shielding panel that shield a first longitudinal end and a second longitudinal end of the cavity.

Furthermore, the base plate may further include a plurality of resonators formed on the first-side body bottom forming panel and the second-side body bottom forming panel.

In addition, at least one of the plurality of resonators may be integrally formed with an input terminal pin connected to an input port so that a signal transmitted from the input port is received. At least one other of the plurality of resonators may be integrally formed with an output terminal pin connected to an output port so that a signal is transmitted to and output from the output port.

### Advantageous Effects

According to a filter for communication devices of the present disclosure, since the filter is configured to allow the construction of structures in a cavity through a simple folding process without using a conventional joining method (welding or brazing), it is possible to reduce insertion loss caused by the application of the joining method, thereby improving communication reliability.

Furthermore, the present disclosure allows the formation of the cavity using a thin base plate of 3 t or less, thereby reducing a thickness direction size of an entire product of an antenna device and enhancing the effects of weight reduction and slimming of the product.

### DESCRIPTION OF DRAWINGS

FIG. 1 is a perspective view illustrating a filter for communication devices according to a first embodiment of the present disclosure,

FIG. 2 is an internal perspective view of FIG. 1,

FIG. 3 is a perspective view illustrating an unfolded state of a base plate among components of FIG. 1,

FIG. 4 is a plan view of FIG. 3,

FIG. 5 is an exploded perspective view illustrating an embodiment in which an input terminal pin and an output terminal pin among the components of FIG. 1 are provided as separate elements,

FIG. 6 shows cutaway perspective views (a and b) taken along line A-A,

FIG. 7 is a cross-sectional view and a partially enlarged plan view illustrating a structure for fixing the input terminal pin and the output terminal pin among the components of FIG. 1,

FIG. 8 is a perspective view illustrating a first implementation of a plurality of resonators among the components of FIG. 1,

FIGS. 9a and 9b are perspective views illustrating a filter for communication devices according to a second embodiment of the present disclosure,

FIGS. 10a and 10b are internal perspective views of FIGS. 9a and 9b.

FIG. 11 is a plan view of a base plate among components of FIG. 9a,

FIG. 12 is an exploded perspective view illustrating an embodiment in which an input terminal pin and an output terminal pin among the components of FIG. 9a are provided as separate elements,

FIG. 13 is a cutaway perspective view of a state in which a portion of a top plate forming part among the components of FIG. 9a is removed along line D-D, and

FIG. 14 shows perspective views of various implementations of a plurality of resonators among the components of FIG. 9a.

<Description of the Reference Numerals>

| | |
|---|---|
| 100: | First embodiment |
| 105: | Base plate |
| 110: | Body bottom forming panel |
| 120: | First-side thickness forming panel |
| 130: | Second-side thickness forming panel |
| 140: | Notch forming panel |
| 150: | Body top forming panel |
| 160: | Resonator panel |
| 170: | Resonators |
| 1100: | Second embodiment |
| 1110A: | First-side body bottom forming panel |
| 1110B: | Second-side body bottom forming panel |
| 1120: | First-side thickness forming panel |
| 1130: | Second-side thickness forming panel |
| 1150: | Body top forming panel |
| 1170: | Resonators |
| 1180A-1: | First first-side shielding panel |
| 1180A-2: | Second first-side shielding panel |
| 1190: | Partition panel |

### BEST MODEL

Hereinafter, a filter for communication devices according to embodiments of the present disclosure will be described in detail with reference to the attached drawings.

In adding reference numerals to elements in each drawing, will be designated by the same reference numerals, if possible, although they are shown in different drawings. Furthermore, in the following description of the disclosure, a detailed description of known functions and configurations incorporated herein will be omitted when it is determined that the description may make the subject matter of the disclosure rather unclear.

The terms “first”, “second”, “A”, “B”, “(a)”, “(b)”, etc. may be used herein to describe various elements of the embodiments of the present disclosure. These terms are only used to distinguish each element from another element, and do not limit the characteristics, turns, or sequences of the corresponding elements. Unless otherwise defined, all terms including technical and scientific terms used herein have the same meaning as commonly understood by one of ordinary skill in the art to which the present disclosure belongs. It will be further understood that terms commonly used and defined in standard dictionaries should be interpreted as having a meaning that is consistent with their meaning in the context of this specification and the relevant art and will not be interpreted in an idealized or overly formal sense unless expressly so defined herein.

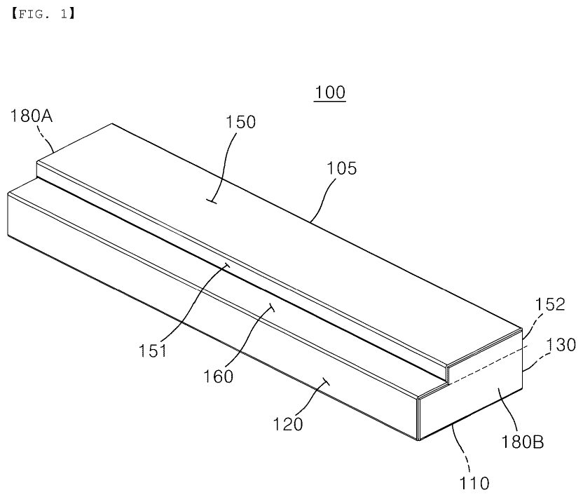

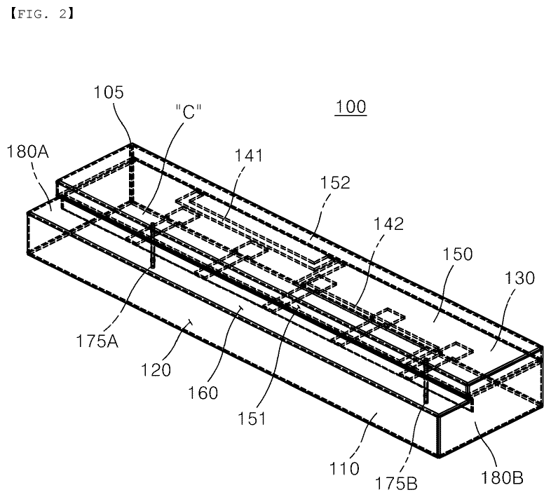

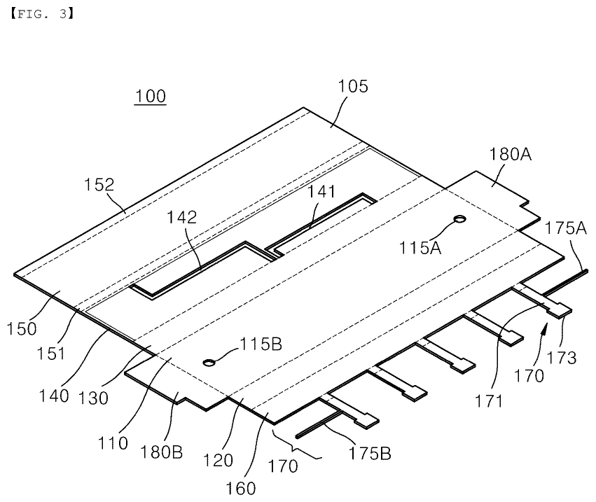

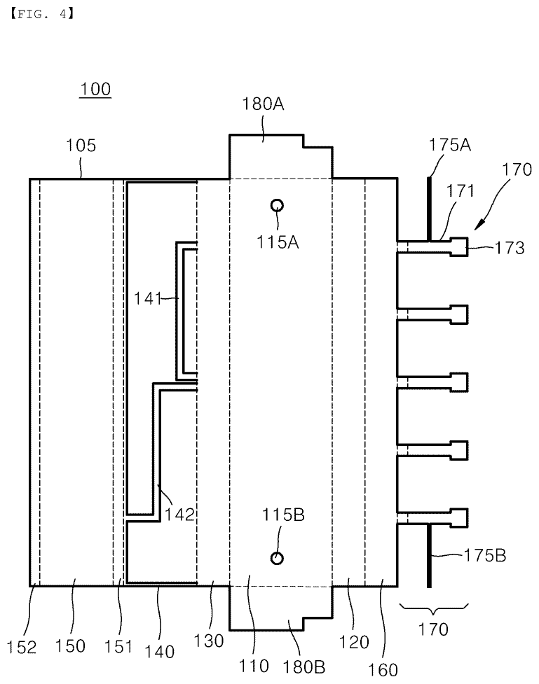

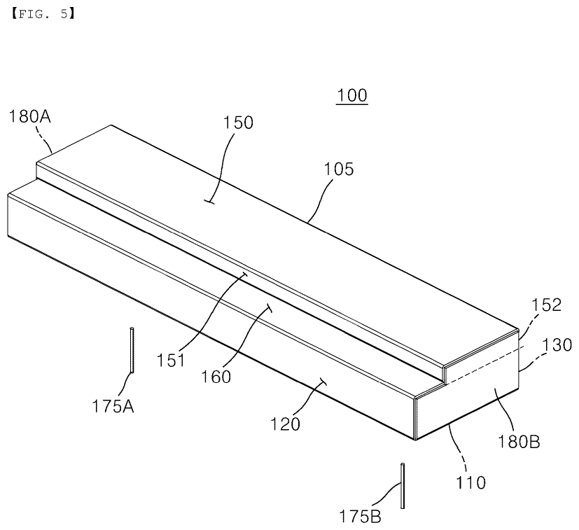

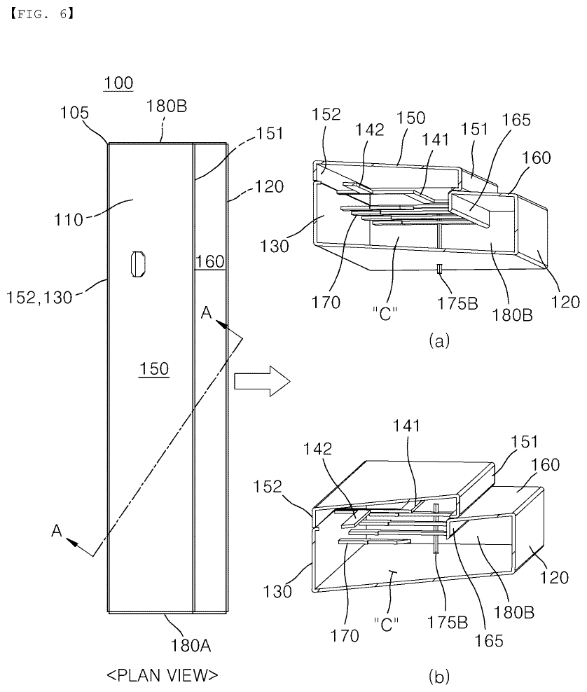

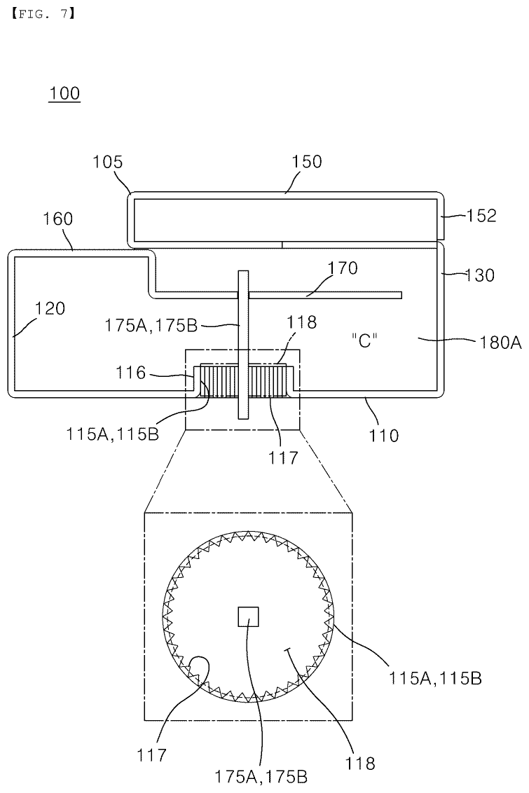

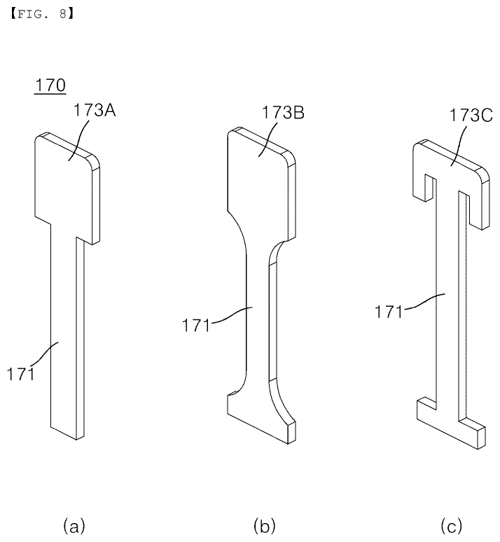

FIG. 1 is a perspective view illustrating a filter for communication devices according to a first embodiment of the present disclosure. FIG. 2 is an internal perspective view of FIG. 1. FIG. 3 is a perspective view illustrating an unfolded state of a base plate among components of FIG. 1. FIG. 4 is a plan view of FIG. 3. FIG. 5 is an exploded perspective view illustrating an embodiment in which an input terminal pin and an output terminal pin among the components of FIG. 1 are provided as separate elements. FIG. 6 shows cutaway perspective views (a and b) taken along line A-A. FIG. 7 is a cross-sectional view and a partially enlarged plan view illustrating a structure for fixing the input terminal pin and the output terminal pin among the components of FIG. 1. FIG. 8 is a perspective view illustrating a first implementation of a plurality of resonators among the components of FIG. 1.

Generally, filters in the field of antenna technology perform a role of filtering signals that need to be input or output to allow only signals within a specific frequency band to pass during signal transmission and reception processes, thereby ensuring that only the signals desired by a consumer (user) are obtained as a final result.

For such signal filtering, a cavity filter, as indicated by the name thereof, forms a cavity as a predetermined signal filtering section between an input port, where signals are input, and an output port, where signals enabling acquisition of specific are output, thereby frequency band signal values within a range desired by the consumer through a frequency tuning process using the cavity.

However, to date, in the industry manufacturing antenna devices, the only disclosed method for manufacturing a cavity filter is a method that includes forming the aforementioned cavity by processing an interior of a filter body made of a ceramic material or a material with higher rigidity, and then separately manufacturing essential components for frequency filtering, such as a plurality of resonators, and fixing the components inside the cavity.

However, the filter communication devices for according to embodiments of the present disclosure departs from the aforementioned manufacturing method and discloses a groundbreaking technical feature that enables the construction of a structure within the cavity without using a separate bonding process by processing a single and flat base plate in the form of sheet metal to a thickness not exceeding a predetermined value, and performing a folding process. Hereinafter, specific technical features will be described sequentially in the order of the embodiments.

A filter 100 for communication devices according to the first embodiment of the present disclosure is manufactured in an unfolded state and includes a conductive base plate 105 configured to be foldable so that when folded, the base plate 105 forms a cavity C therein and allows a plurality of resonators 170, which protrude a predetermined length in the thickness direction or width direction, to be positioned inside the cavity C.

The base plate 105 is preferably made of a conductive material; however, it should be noted in advance that the base plate 105 may also be made of a non-conductive material for ease of manufacturing, and to enable the cavity C to perform the function thereof, a conductive material may subsequently form a coating layer by plating on both the interior and exterior, including the cavity C, or at least on the interior corresponding to the cavity C.

However, the base plate 105 is preferably made of a deformable material that can be suitably processed, as the base plate 105 is required to continuously maintain the shape thereof after being deformed through the folding process, as described below, unless subjected to an external force.

Here, the cavity C is a dielectric-filled space in which a dielectric material having a predetermined dielectric constant is filled, referring to a space that remains empty to allow the dielectric material to be charged. Since air is also a type of dielectric with a dielectric constant of 1, it should be noted in advance that when atmospheric-pressure air is adopted as the dielectric material, a separate dielectric filling process is not required.

In the filter 100 for communication devices according to the first embodiment of the present disclosure, the base plate 105 serves to form the cavity C, which functions as a dielectric-filled space.

Here, as referenced in FIGS. 3 and 4, the base plate 105 may include: a body bottom forming panel 110, which forms a bottom surface of the cavity C after folding; a first-side thickness forming panel 120 and a second-side thickness forming panel 130, which extend in a plane from a first widthwise end and a second widthwise end of the body bottom forming panel 110 such that the width of the body bottom forming panel 110 increases, thereby increasing the size of the cavity C in the thickness direction; a resonator panel 160, which extends from a distal end of either the first-side thickness forming panel 120 or the second-side thickness forming panel 130 and is provided with a plurality of resonators 170 that protrude into the cavity C at a position corresponding to space above the body bottom forming panel 110; and a body top forming panel 150, which extends from a distal end of a remaining one of the first-side thickness forming panel 120 and the second-side thickness forming panel 130 and is provided in a shape covering the top of the cavity C to face the body bottom forming panel 110.

Furthermore, a first-side shielding panel 180A and a second-side shielding panel 180B, which shield an open first longitudinal end and an open second longitudinal end of the cavity C, may integrally extend from the first longitudinal end and the second longitudinal end of the body bottom forming panel 110.

Here, the first-side shielding panel 180A and the second-side shielding panel 180B are described as being integrally formed with the body bottom forming panel 110, but it is apparent that, depending on the embodiment, the first-side shielding panel 180A and the second-side shielding panel 180B may also be symmetrically and integrally provided on an adjacent panel, such as the body top forming panel 150. Furthermore, the first-side shielding panel 180A and the second-side shielding panel 180B may be integrally formed with adjacent panels to be separately provided in two components, respectively, and may be configured to completely shield the open portions of the cavity C through the folding operation.

The body bottom forming panel 110 may be provided with an input port installation portion 115A and an output port installation portion 115B, which are respectively formed to vertically penetrate the first longitudinal end and the second longitudinal end. An input terminal pin 175A, which will be described later, may be installed through the input port installation portion 115A, and an output terminal pin 175B, which will be described later, may be installed through the output port installation portion 115B.

Particularly, as referenced in FIG. 7, the input port installation portion 115A and the output port installation portion 115B are formed as circular holes larger than the horizontal cross-sectional area of the input terminal pin 175A or the output terminal pin 175B. A portion of an edge of each of the holes may protrude a predetermined length inward into the cavity C to form a boss portion 116.

Here, a Teflon component 118 is provided on an outer surface of the input terminal pin 175A or the output terminal pin 175B for impedance matching. A fixing protrusion portion 117 having a stud or serration-like projection shape is integrally formed, to ensure stable installation of the Teflon component 118, on an inner circumferential surface of the hole in each of the input port installation portion 115A and the output port installation portion 115B, where the boss portion 116 is provided. The Teflon component 118 is press-fitted into and securely fixed to the hole, thereby minimizing insertion loss.

In addition, as referenced in FIGS. 3 and 4, the base plate 105 may further include a notch forming panel 140, which is provided between the body top forming panel 150, which connects the first-side thickness forming panel 120 and the second-side thickness forming panel 130, and the resonators 170 of the resonator panel 160. The notch forming panel 140 is arranged to extend in a horizontal direction (or thickness direction) in the cavity C.

The notch forming panel 140 is provided in the form of a frame that is penetrated in the vertical direction, having a shape corresponding to a peripheral shape of the cavity C, and may be formed with an L-notch portion 141 and a C-notch portion 142, each having a specific shape, at a first inner end and a second inner end in the width direction.

The L-notch portion 141 and the C-notch portion 142 are not necessarily required to be provided on the notch forming panel 140, and it is apparent that the L-notch portion 141 and the C-notch portion 142 may be integrally formed on the body top forming panel 150, as long as they can be subsequently modified within a permissible range inside the cavity C by an operator who performs frequency tuning later.

As referenced in FIGS. 3 and 4, in the case where the notch forming panel 140 is provided together with the body top forming panel 150, a first-side spacing panel 151 and a second-side spacing panel 152, which space the notch forming panel 140 and the body top forming panel 150 apart from each other in the thickness direction within the cavity C, may be further integrally provided on the base plate 105.

Here, a lower end of the second-side spacing panel 152 may be welded to an upper end of the second-side thickness forming panel 130, which is a starting portion (first end) where the notch forming panel 140 is formed, after the folding of the body top forming panel 150 is completed.

Furthermore, an ending portion (second end) of the notch forming panel 140, which corresponds to a lower end of the first-side spacing panel 151, may be welded to an upper surface of a portion of the resonator panel 160 that overlaps the ending portion in the thickness direction, after the folding of the resonator panel 160 is completed.

The body top forming panel 150 may be integrally formed, by cutting, with frequency tuning bars (not shown), which perform fine frequency tuning by adjusting a separation distance from the plurality of resonators 170 that are arranged to form a single layer in the thickness direction inside the cavity C, and a plurality of coupling adjustment bars (not shown), which are each deformed directly downward between the plurality of resonators 170.

It is apparent that the body top forming panel 150 may be formed with a tool insertion hole (not shown) penetrating vertically to allow the aforementioned L-notch portion 141 and C-notch portion 142 to be deformed using a predetermined tool.

As referenced in FIGS. 2 to 7, for example, on the assumption that the cavity C, generated by folding each portion of the base plate 105, is formed as a slim rectangular parallelepiped that is relatively long in a longitudinal direction and has a markedly small vertical thickness compared to front-rear and width directions, the plurality of resonators 170 may be provided to form a single uniform layer in the thickness direction of the cavity C.

The L-notch portion 141 and the C-notch portion 142 provided on the notch forming panel 140 may also form a single uniform layer in the thickness direction of the cavity C but may be provided to form a distinct single layer separate from the aforementioned plurality of resonators 170.

Since the thickness of each of the single layer formed by the plurality of resonators 170 and the single layer formed by the L-notch portion 141 and the C-notch portion 142 corresponds to none other than the thickness of the base plate 105 and the single layer is provided with a markedly slim thickness, it provides the advantage of enabling a slim design as desired by the designer without increasing the overall size, including the thickness of the entire product.

As referenced in FIG. 8, the plurality of resonators 170 may each include, at a distal end portion thereof, a resonance characteristic end 173 that is flat to form the same layer as a remaining portion within the cavity C and has a wider width than the remaining portion. Hereinafter, for convenience of explanation, among the structural portions of each of the plurality of resonators 170, a body portion that integrally extends from the base plate 105 and is connected at the distal end portion thereof to the resonance characteristic end 173 is referred to as a resonance bar 171.

At least one of the plurality of resonators 170 may be integrally formed with the input terminal pin 175A that is connected to an input port (not shown) so that a signal transmitted from the input port is input to the at least one resonator 170. At least one other of the plurality of resonators 170 may be integrally formed with an output terminal pin 175B that is connected to an output port (not shown) so that a signal is transmitted to the output port and then output.

As referenced in FIG. 8a, the resonance characteristic end 173 of each of the plurality of resonators 170 may integrally extend to be angled from the leading end of the remaining portion (resonance bar 171).

Alternatively, as referenced in FIG. 8b, the resonance characteristic end 173 of each of the plurality of resonators 170 may integrally extend to be rounded from the leading end of the remaining portion (resonance bar 171).

As a final example, as referenced in FIG. 8c, the resonance characteristic end 173 of each of the plurality of resonators 170 may integrally extend in a ‘U’ shape that surrounds the leading end of the remaining portion (resonance bar 171).

A brief explanation of a method for manufacturing the filter for communication devices according to the first embodiment of the present invention, which is configured as described above, is as follows.

First, after preparing the base plate 105 made of a conductive or non-conductive material (a base plate preparation process), the base plate 105 may be transferred to a press mold and subjected to press sheet metal processing in a pre-designed shape (a press sheet metal processing process).

In this case, as described above, the base plate 105 is preferably designed as a sheet metal structure to form the cavity C, which is shielded from the outside by the body bottom forming panel 110, the first-side thickness forming panel 120, the second-side thickness forming panel 130, the first-side shielding panel 180A, the second-side shielding panel 180B, the body top forming panel 150, and other panels directly connected thereto (e.g., the first-side spacing panel 151 and the second-side spacing panel 152), through a folding process described later.

After performing press sheet metal processing on the base plate 105 through the press sheet metal processing process, in the case where the base plate 105 is made of a non-conductive material, a separate conductive coating process may be additionally performed so that a conductive material forms a coating layer on the entire interior of at least the cavity C, and subsequently, a folding process may be sequentially performed to form the cavity C.

Here, the folding process includes sequentially folding the panels associated with forming the cavity C from the bottom to the top, with reference to the body bottom forming panel 110. During the folding process, the panels are folded so that the plurality of resonators 170 formed on the resonator panel 160 form the same layer (or a single layer) within the cavity C, while the L-notch portion 141 and the C-notch portion 142 formed on the notch forming panel 140 form a distinct single layer separate from the plurality of resonators 170 within the cavity C.

The embodiment of the filter for communication devices according to the present disclosure is not necessarily limited to the aforementioned first embodiment 100, as long as the cavity C is formed through a process of folding the base plate 105. Hereinafter, a filter 1100 for communication devices according to a second embodiment of the present disclosure will be described in detail.

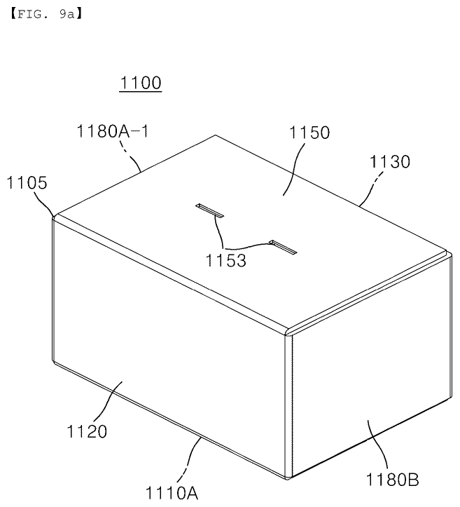

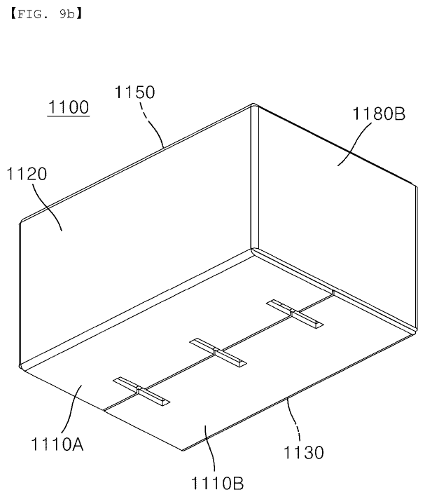

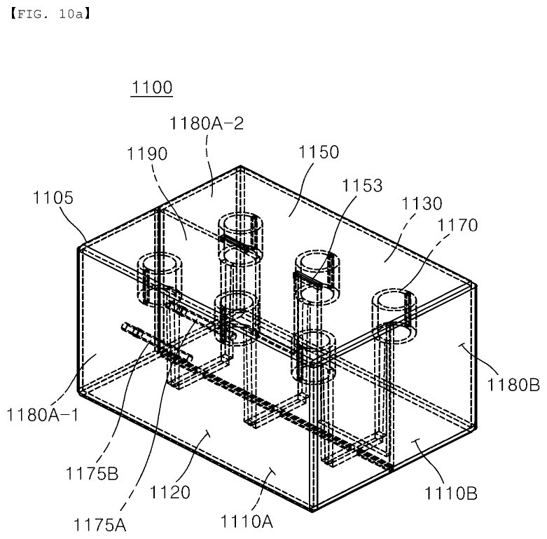

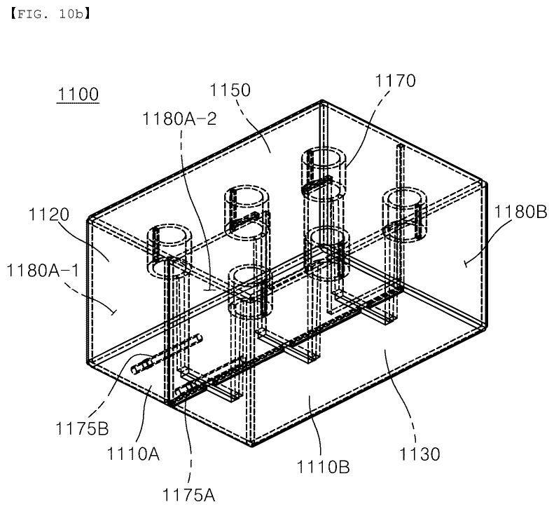

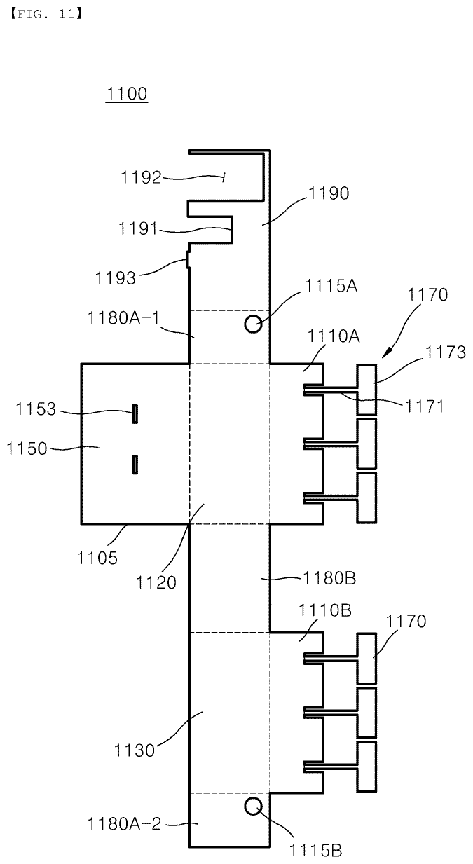

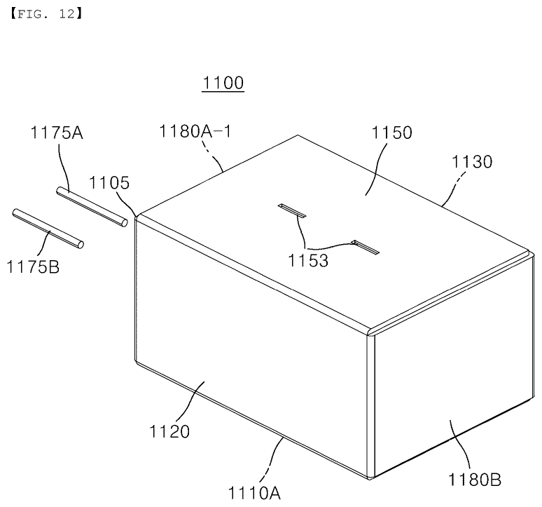

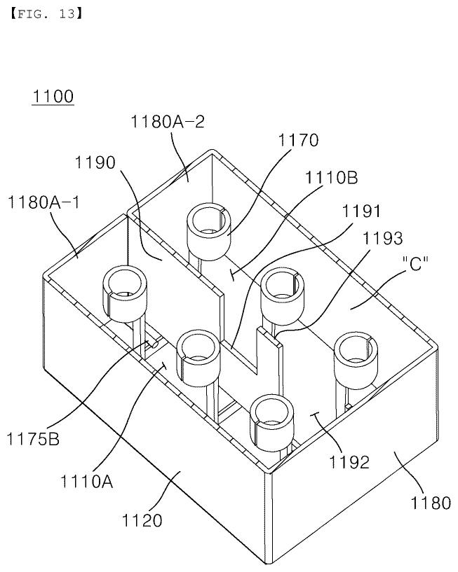

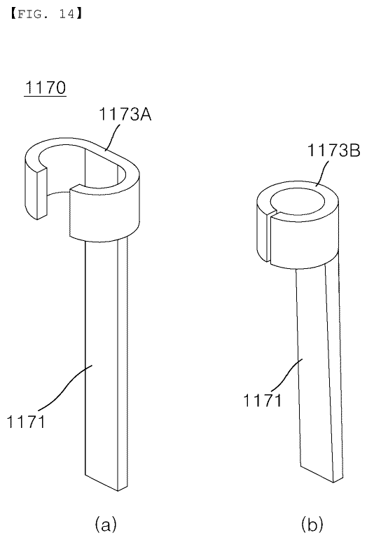

FIGS. 9a and 9b are perspective views illustrating a filter for communication devices according to a second embodiment of the present disclosure. FIGS. 10a and 10b are internal perspective views of FIGS. 9a and 9b. FIG. 11 is a plan view of a base plate among components of FIG. 9a. FIG. 12 is an exploded perspective view illustrating an embodiment in which an input terminal pin and an output terminal pin among the components of FIG. 9a are provided as separate elements. FIG. 13 is a cutaway perspective view of a state in which a portion of a top plate forming part in the components of FIG. 9a is removed along line D-D. FIG. 14 shows perspective views of various implementations of a plurality of resonators among the components of FIG. 9a.

In a filter 1100 for communication devices according to the second embodiment of the present disclosure, as referenced in FIGS. 9A to 14, a base plate 1105 may include: a first-side body bottom forming panel 1110A that forms a first-side bottom surface of a cavity C after folding; a second-side body bottom forming panel 1110B that forms a second-side bottom surface of the cavity C; a first-side thickness forming panel 1120 and a second-side thickness forming panel 1130 that extend from a widthwise outer end of the first-side body bottom forming panel 1110A and a widthwise outer end of the second-side body bottom forming panel 1110B, respectively, thereby increasing the size of the cavity C in the thickness direction; a first first-side shielding panel 1180A-1 that extends from a first longitudinal end of the first-side thickness forming panel 1120 by a half-width size; a second first-side shielding panel 1180A-2 that extends from a second longitudinal end of the second-side thickness forming panel 1130 by a half-width size; a second-side shielding panel 1180B that extends by a width size to connect a second longitudinal end of the first-side thickness forming panel 1120 and a first longitudinal end of the second-side thickness forming panel 1130; and a body top forming panel 1150 that is formed to extend from a second widthwise end of the first-side thickness forming panel 1120, opposite to a first widthwise end thereof on which the first-side body bottom forming panel 1110A is formed, the body top forming panel 1150 being provided to cover the top of the cavity C while facing the first-side body bottom forming panel 1110A and the second-side body bottom forming panel 1110B.

A plurality of resonators 1170 that extend in the thickness direction toward the body top forming panel 1150 from the inner bottom of the cavity C may be provided on an outer end of the first-side body bottom forming panel 1110A and an outer end of the second-side body bottom forming panel 1110B.

More specifically, some (three) resonators among the plurality of resonators 1170 may be formed on the outer end of the first-side body bottom forming panel 1110A and may be bent from a bottom of a resonance cutout, which is recessed to a predetermined depth inward in a width direction of the first-side body bottom forming panel 1110A. Remaining (three) resonators among the plurality of resonators 1170 may be formed on the outer end of the second-side body bottom forming panel 1110B and may be bent from a bottom of a resonance cutout, which is recessed to a predetermined depth inward in a width direction of the second-side body bottom forming panel 1110B. As a result, the resonators 1170 may form two rows in the thickness direction in the cavity C and protrude toward the body top forming panel 1150.

Furthermore, the filter 1100 for communication devices according to the second embodiment of the present disclosure may further include a partition panel 1190 that is provided at an outer end of either the first first-side shielding panel 1180A-1 or the second first-side shielding panel 1180A-2 and is folded inward into the cavity C during the folding process to spatially divide the cavity C into both sides in the width direction.

By comparing the filter 1100 for communication devices according to the second embodiment of the present disclosure, which has the above-described configuration, with the filter 100 for communication devices according to the first embodiment of the present disclosure, the differences are explained as follows.

First, in the case of the filter 100 for communication devices according to the first embodiment of the present disclosure, the body bottom forming panel 110 that forms the bottom of the cavity C is formed as a single integrated panel. In contrast, in the case of the filter 1100 for communication devices according to the second embodiment of the present disclosure, the body bottom forming panels that form the bottom of the cavity C are provided as two separate panels 1110A and 1110B in the width direction of the cavity C. The plurality of resonators 1170 may be integrally formed on one end of each of the separated body bottom forming panels 1110A and 1110B so as to be foldable in the thickness direction of the cavity C from the one end of each of the body bottom forming panels 1110A and 1110B, without requiring a separate resonator panel.

The first-side body bottom forming panel 1110A and the second-side body bottom forming panel 1110B, which are provided as two separate panels, come into contact with each other at respective outer ends thereof during a subsequent folding process, thereby forming the complete bottom surface of the cavity C.

Furthermore, in the filter 100 for communication devices according to the first embodiment of the present disclosure, the first-side thickness forming panel 120 and the second-side thickness forming panel 130 extend from the first widthwise end and the second widthwise end of the body bottom forming panel 110, respectively, and the first-side shielding panel 180A and the second-side shielding panel 180B extend from the first longitudinal end and the second longitudinal end of the body bottom forming panel 110, respectively. In contrast, in the filter 1100 for communication devices according to the second embodiment of the present disclosure, the first-side thickness forming panel 1120 and the second-side thickness forming panel 1130 integrally extend to be foldable from the second ends of the body bottom forming panels 1110A and 1110B, respectively, and the first-side thickness forming panel 1120 and the second-side thickness forming panel 1130 may be integrally connected to each other by the second-side shielding panel 1180B.

Additionally, in the filter 1100 for communication devices according to the second embodiment of the present disclosure, among both widthwise ends of the first-side thickness forming panel 1120, the body top forming panel 1150 integrally extends from an opposing second widthwise end of the first-side thickness forming panel 1120, where the body bottom forming panel 1110A is not formed. Moreover, among the first and second longitudinal ends of the first-side thickness forming panel 1120 and the second-side thickness forming panel 1130, at the corresponding longitudinal ends where the aforementioned second-side shielding panel 1180B is not formed, the first first-side shielding panel 1180A-1 and the second first-side shielding panel 1180A-2 may be integrally formed, each occupying half of the area.

Particularly, in the filter 1100 for communication devices according to the second embodiment of the present disclosure, the partition panel 1190, in which at least one or more windows 1191 and 1192 are cut out, may be integrally formed on a longitudinal end of any one of the first-side shielding panels 1180A-1 and 1180A-2, thereby spatially dividing the cavity C into two sections at opposite sides in the width direction.

In the filter 1100 for communication devices according to the second embodiment of the present disclosure, as referenced in FIG. 14, a plurality of resonators 1170, which are integrally formed with the body bottom forming panels 1110A and 1110B, may each include a resonance characteristic end 1173 formed in such a way that a distal end portion of a resonance bar 1171 has a wider width than a remaining portion and opposite widthwise ends of the distal end portion are curled in a rounded shape in one thickness direction from a leading end of the remaining portion.

More specifically, as referenced in (a) and (b) in FIG. 14, in the resonance characteristic ends 1173A and 1173B of the plurality of resonators 1170, the opposite widthwise ends in a rounded state may be spaced apart from each other by a predetermined distance.

The resonance characteristic ends 1173A of the plurality of resonators 1170 may each be formed to have at least one circular horizontal cross-section (refer to (b) in FIG. 14) or semicircular horizontal cross-section (refer to (a) in FIG. 14).

Furthermore, in the filter 100 for communication devices according to the first embodiment of the present disclosure, the input terminal pin 175A and the output terminal pin 175B are each integrally formed with one of the resonators 170 and then fixedly installed by penetrating the corresponding one of the input port installation portion 115A and the output port installation portion 115B formed in the body bottom forming panel 110 during the folding process. In contrast, in the filter 1100 for communication devices according to the second embodiment of the present disclosure, an input terminal pin 1175A and an output terminal pin 1175B are provided as separate elements and fixedly installed by penetrating the input port installation portion 1115A formed in the first first-side shielding panel 1180A-1 and the output port installation portion 1115B formed in the second first-side shielding panel 1180A-2, respectively.

The input terminal pin 1175A may be connected to an input port formed in an unillustrated main board and to one of the plurality of resonators 1170 so that a signal transmitted from the input port is received. The output terminal pin 1175B may be connected to an output port formed in the unillustrated main board and to one of the plurality of resonators 1170 so that a signal is transmitted to the output port and then output.

In the second embodiment 1100, a folding method and sequence of the base plate 1105 follow those referenced in FIG. 11.

Thus far, the filters 100 and 1100 for communication devices according to the embodiments of the present disclosure have been described in detail with reference to the accompanying drawings. However, embodiments of the present disclosure are not limited to the foregoing embodiments, and it is apparent to those skilled in the art that various changes may be made thereto without departing from the claims and equivalents thereof. Accordingly, the true scope of the present disclosure should be defined by the appended claims.

### INDUSTRIAL APPLICABILITY

The present disclosure provides a filter for communication devices that can eliminate conventional joining processes for forming a cavity and providing structures such as resonators within the cavity, thereby reducing insertion loss caused by coupling of two physical structures.

1. A filter for communication devices, comprising
a base plate made of a conductive material, and manufactured in an unfolded state, the base plate being configured foldable such that, upon folding, a cavity is formed inside while simultaneously positioning a plurality of resonators to protrude by a set length in a thickness direction or a width direction in the cavity,
wherein the plurality of resonators each have a distal end portion having a wider width than a remaining portion, and include a resonance characteristic end formed by curling opposite widthwise ends of the distal end portion in a rounded shape in one thickness direction from a leading end of the remaining portion.

2. The filter of claim 1,
wherein at least one of the plurality of resonators is connected with an input terminal pin that is provided as a separate element and connected to an input port of a main board so that a signal transmitted from the input port is received, and
wherein at least one other of the plurality of resonators is connected with an output terminal pin that is provided as a separate element and connected to an output port of the main board so that a signal is transmitted to the output port and then output.

3. The filter of claim 1, wherein the opposite rounded widthwise ends of the resonance characteristic end of each of the plurality of resonators are spaced apart from each other by a set distance.

4. The filter of claim 1, wherein the resonance characteristic end of each of the plurality of resonators is formed to have at least one circular or semicircular horizontal cross-section.

5. The filter of claim 1,
wherein the base plate is made of either a conductive material or a non-conductive material, and
wherein in case that the base plate is made of the non-conductive material, a conductive material is formed as a coating layer by plating at least on an interior corresponding to the cavity.

6. The filter of claim 1, wherein the cavity is filled with air having a dielectric constant of 1.

7. The filter of claim 1, wherein the base plate, after folding, comprises:
a body bottom forming panel that forms a bottom surface of the cavity;
a first-side thickness forming panel and a second-side thickness forming panel that increase a size of the cavity in the thickness direction; and
a body top forming panel provided in a shape covering a top of the cavity.

8. The filter of claim 7, wherein the body bottom forming panel comprises:
a first-side body bottom forming panel that forms a first-side bottom surface of the cavity; and
a second-side body bottom forming panel that forms a second-side bottom surface of the cavity, and
wherein the first-side body bottom forming panel and the second-side body bottom forming panel form a complete bottom surface of the cavity after folding.

9. The filter of claim 7, wherein the base plate, after folding, further comprises a first-side shielding panel and a second-side shielding panel shield that a first longitudinal end and a second longitudinal end of the cavity.

10. The filter of claim 8,
wherein the base plate further comprises a plurality of resonators formed on the first-side body bottom forming panel and the second-side body bottom forming panel.
